(19) United States
(12) Patent Application Publication
(10) Pub. No.: US 2012/0106161 A1
(43) Pub. Date: May 3, 2012

(54) LED LAMP

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/280,357

(22) Filed: Oct. 25, 2011

(30) Foreign Application Priority Data
Oct. 29, 2010 (TW) 099137172

(51) Int. Cl. F21V 21/26

(52) U.S. Cl. 362/269

(57) ABSTRACT

An exemplary LED lamp includes a bracket, a first lamp cover fixed on a first side of the bracket, a second lamp cover fixed on a second side of the bracket, and an LED module pivotally engaging with the bracket. The LED module has an LED and a weight on opposite faces of a base of the LED module. The second lamp cover is different from the first lamp cover. The LED module is capable of rotating relative to the bracket to have the LED thereof face either one of first lamp cover and the second lamp cover.

### BACKGROUND

1. Technical Field

The disclosure relates to illumination devices, and particularly to an LED lamp.

2. Description of the Related Art

Light emitting diodes (LEDs) have many advantages, such as high luminosity, low operational voltage, low power consumption, compatibility with integrated circuits, easy driving, long term reliability, and environmental friendliness. Such advantages have promoted the wide use of LEDs as a light source. Now, LEDs are commonly applied in lighting.

A conventional LED lamp generally includes an LED module and a lamp cover covering the LED module. Light emitted from the LED module is radiated outwardly through the lamp cover. However, under this situation, one individual LED lamp only gets one kind of light-emitting effect. If a user wants to get different kinds of light-emitting effect, he (she) must change the LED module or the lamp cover of the LED lamp. The use of the LED lamp is limited.

Therefore, it is desirable to provide an LED lamp which can overcome the above-described problems.

### BRIEF DESCRIPTION OF THE DRAWINGS

Many aspects of the present LED lamp can be better understood with reference to the following drawings. The components in the drawings are not necessarily drawn to scale, the emphasis instead being placed upon clearly illustrating the principles of the present LED lamp. Moreover, in the drawings, like reference numerals designate corresponding parts throughout the several views.

FIG. 1 is a schematic, assembled view of an LED lamp in accordance with an exemplary embodiment.

FIG. 2 is an exploded view of the LED lamp of FIG. 1.

FIG. 3 is an inverted, exploded view of the LED lamp of FIG. 1.

FIG. 4 is a cross sectional view of the LED lamp of FIG. 1, taken along a line IV-IV thereof.

FIG. 5 is an enlarged view of the LED lamp of FIG. 1 with a first lamp cover and a second lamp cover omitted for purposes of illustration.

FIG. 6 is another schematic, assembled view of the LED lamp of FIG. 1, wherein the LED lamp is reversed.

### DETAILED DESCRIPTION

An embodiment of an LED lamp as disclosed is described in detail here with reference to the drawings.

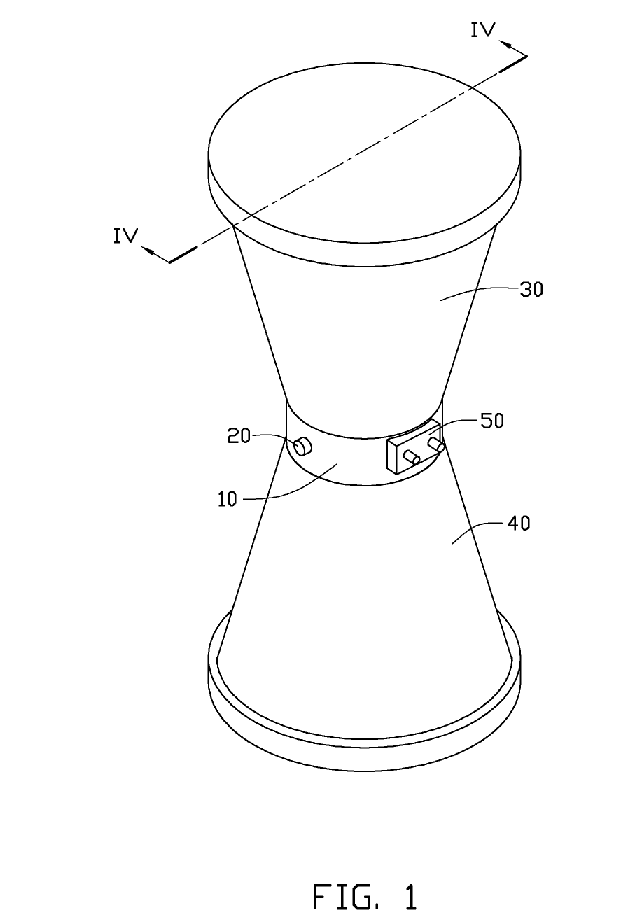

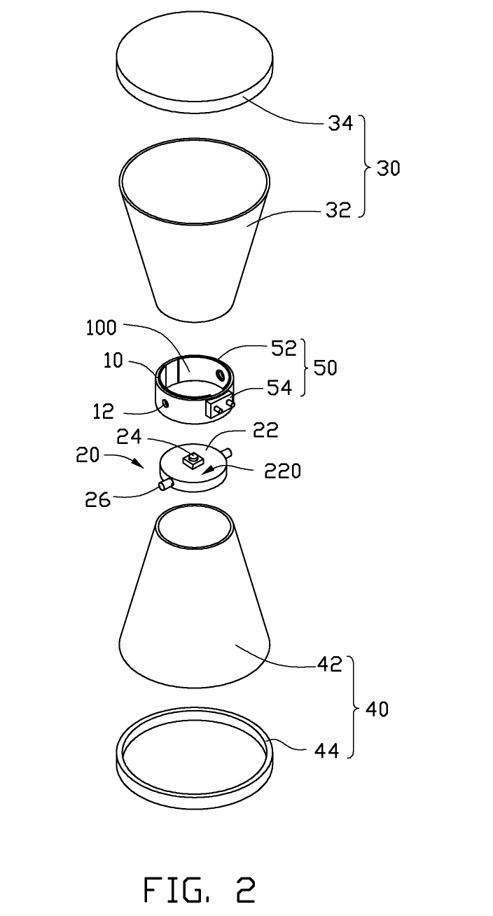

Referring to FIGS. 1-2, an LED lamp in accordance with an exemplary embodiment of the disclosure includes an annular bracket 10, an LED module 20 pivotally received in the bracket 10, a first lamp cover 30 fixed on a top side of the bracket 10, and a second lamp cover 40 attached to a bottom side of the bracket 10.

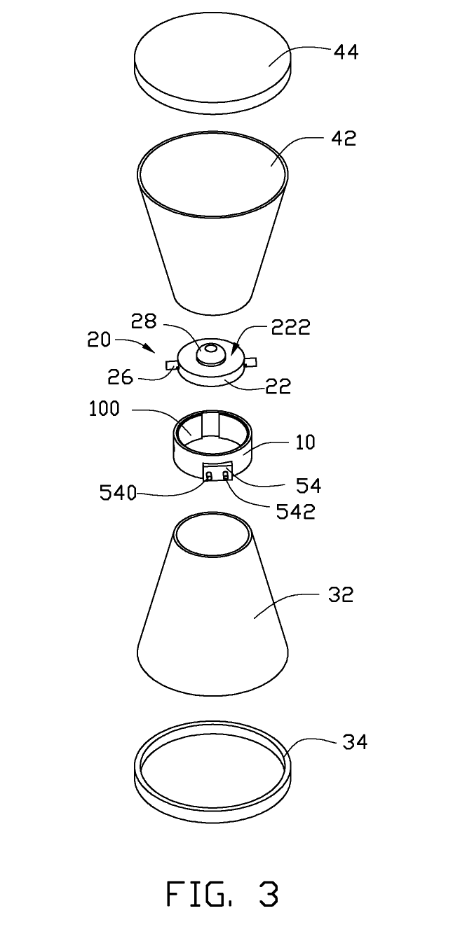

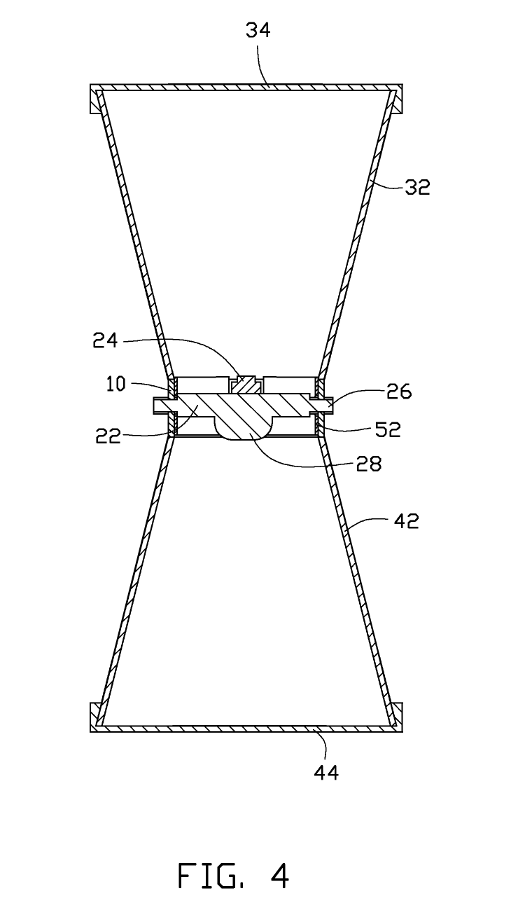

Referring to FIGS. 3 and 4 also, the bracket 10 is a circular ring. It can be understood that, the bracket 10 could also be a rectangle ring or an ellipse ring. Two engaging holes 12 are defined in the bracket 10 and opposite to each other. The LED lamp further includes an electrical connector module 50 mounted on the bracket 10. The electrical connector module 50 is electrically connected between the LED module 20 and an outer power source (not shown), to thus supply an electric power to the LED module 20. The electrical connector module 50 includes two conductive plates 52 and a connector 54 interconnecting the two conductive plates 52. The connector 54 has a positive electrode 540 connected to one conductive plate 52 and a negative electrode 542 connected to the other conductive plate 52. The two conductive plates 52 are insulated and spaced from each other. The two conductive plates 52 are both arc-shaped and respectively attached to an inner face of the annular bracket 10.

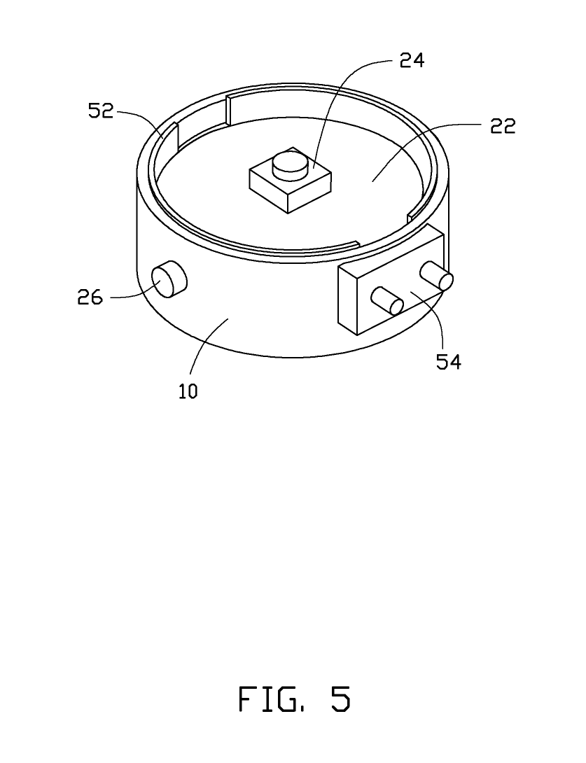

Referring to FIG. 5 also, the LED module 20 includes a base 22, an LED 24 mounted on the base 22, two pivot rods 26 respectively extending outwardly from two diametrically opposite lateral sides of the base 22, and a weight 28 (as shown in FIG. 4) extending downwardly from the base 22. The base 22 is a circular flat plate. The base 22 is received in the bracket 10. An outer periphery of the base 22 is attached to inner faces of the two conductive plates 52 of the electrical conductor module 50. The base 22 is electrically connected to the two conductive plates 52. The two pivot rods 26 are pivotally received in the engaging holes 12 respectively. The base 22 of the LED module 20 is rotatable relative to the bracket 10 by rotating with the two pivot rods 26. The base 22 has a first face 220 and a second face 222 opposite to the first face 220. In the embodiment of this disclosure, the first face 220 is a top face of the base 22, and the second face 222 is a bottom face of the base 22. The LED 24 is disposed at a center of the first face 220. The weight 28 extends downwardly from a center of the second face 220. The weight 28 is aligned with a barycenter of the LED module 20. For a weight of the LED 24 is much smaller that that of the weight 28, so the LED 24 keeps facing upwardly under an action of gravity. It could be understood that, if the LED 24 is disposed at the second face 222 as same as the weight 28, the LED 24 would keep facing downwardly.

The annular bracket 10 defines two openings 100 at opposite top and bottom ends thereof, respectively. The first lamp cover 30 is disposed on the bracket 10 and correspondingly covers one opening 100, and the second lamp cover 40 is disposed on the bracket 10 opposite to the first lamp cover 30 and correspondingly covers the other opening 100. The first lamp cover 30 and the second lamp cover 40 are symmetrical relative to the bracket 10. The first lamp cover 30 and the second lamp cover 40 are made of transparent or semitransparent materials such as glass, resin or plastic. The first lamp cover 30 and the second lamp cover 40 are funnel-shaped. The first lamp cover 30 includes a first body 32 engaging with the bracket 10 and a first cover 34 covering the first body 32. The second first lamp cover 40 includes a second body 42 engaging with the bracket 10 and a second cover 44 covering the second body 42. In the embodiment of this disclosure, a smaller end of the first body 32 is fixed on the bracket 10, and a smaller end of the second body 42 is fixed on the bracket 10. The first lamp cover 30 is different from the second lamp cover 40 in colors, such as that the first lamp cover 30 is blue, while the second lamp cover 40 is yellow or red, or in materials, such as that the first lamp cover 30 is made of transparent glass while the second lamp cover 40 is made of semitransparent plastic.

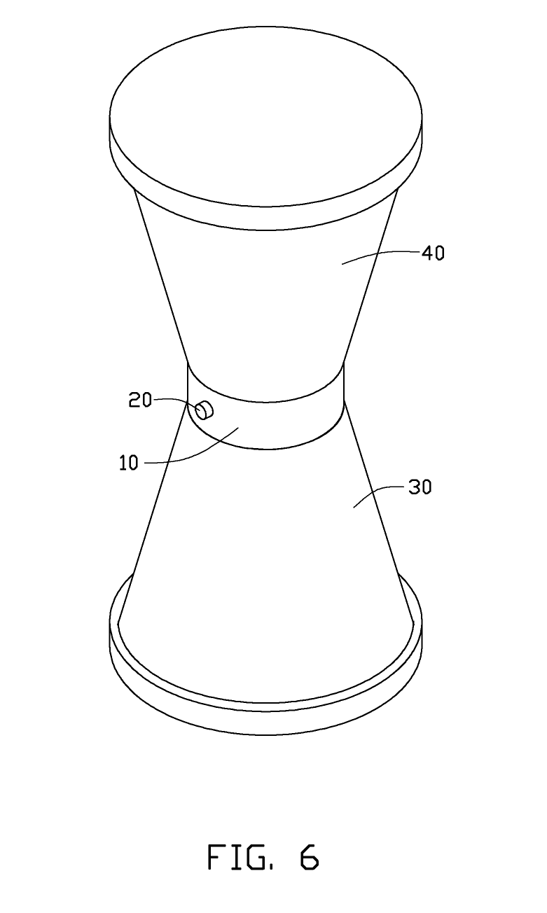

In use, the LED lamp is disposed on a horizontal plane (not shown), such as a floor, a table or a desk. In a first working state of the LED lamp as FIGS. 1 and 4 show, the first lamp cover 30 is located over the second lamp cover 40; the LED 24 faces upwardly and light emitted by the LED 24 is radiated outwardly through the first lamp cover 30. In a second working state of the LED lamp, as FIG. 6 shows, the LED lamp is reversed, and the bracket 10 with the first lamp cover 30 and the second lamp cover 40 are reversed to make the second lamp cover 40 locate over the first lamp cover 30, wherein under the action of the gravity, the LED module 20 is rotated with the two pivot rods 26 about 180 degrees; thus the LED 24 is kept facing upwardly, and the light emitted by the LED 24 is radiated outwardly through the second lamp cover 40. Thus, the LED lamp according to the present disclosure can easily get two kinds of light-emitting effect, without changing any component thereof.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. An LED (light emitting diode) lamp comprising:
an annular bracket;
a first lamp cover fixed on a first side of the bracket;
a second lamp cover fixed on a second side different from the first side of the bracket, and the second lamp cover being different from the first lamp cover; and
an LED module pivotally engaging with the bracket, the LED module being capable of rotating relative to the bracket to face either one of first lamp cover and the second lamp cover.

2. The LED lamp of claim 1, wherein the LED module comprises a base and an LED mounted on the base.

3. The LED lamp of claim 1, wherein the base of the LED module comprises a first face and a second face opposite to the first face, the LED being mounted on the first face, and the LED module further comprises a weight extending outwardly from the second face.

4. The LED lamp of claim 3, wherein the weight is aligned with a barycenter of the LED module.

5. The LED lamp of claim 3, wherein the weight of the base has a weight larger than that of the LED on the first face of the base.

6. The LED lamp of claim 3, wherein the LED faces the first lamp cover in a first state, and the LED faces the second lamp cover in a second state after the LED module is rotated relative to the bracket.

7. The LED lamp of claim 2, wherein the bracket defines two engaging holes, and the base further comprises two pivot rods pivotally engaging in the engaging holes of the bracket, respectively.

8. The LED lamp of claim 3, wherein the base is received in the bracket.

9. The LED lamp of claim 8 further comprising an electrical connector module fixed on the bracket for supplying electric power to the LED module.

10. The LED lamp of claim 9, wherein the electrical connector module comprises two conductive plates electrically connecting with the LED module and a connector interconnecting the two conductive plates and adapted for connecting with an external electric power source.

11. The LED lamp of claim 10, wherein each of the conductive plates is configured to be attached to an inner face of the bracket.

12. The LED lamp of claim 1, wherein the first lamp cover is different from the second lamp cover in color.

13. The LED lamp of claim 1, wherein the first lamp cover is different from the second lamp cover in materials.

14. An LED (light emitting diode) lamp comprising:
an LED module comprising a base and an LED mounted on the base; and
a first lamp cover and a second lamp cover respectively disposed on two opposite sides of the LED module and covering the LED module, and the second lamp cover being different from the first lamp cover;
wherein the LED module is kept facing upwardly under an action of gravity, and the LED module is capable of rotating relative to the first lamp cover and the second lamp cover, whereby the LED faces to the first lamp cover in a first state, and the LED faces to the second lamp cover in a second state after the LED module is rotated relative to the first lamp cover and the second lamp cover.

15. The LED lamp of claim 14, wherein the base of the LED module comprises a first face and a second face opposite to the first face, the LED is mounted on the first face, and a weight is formed on the second face of the base.

16. The LED lamp of claim 15, wherein the weight is aligned with a barycenter of the LED module.

17. The LED lamp of claim 16, wherein the weight formed on the second face has a weight larger than that of the LED mounted on the first face of the base.

18. The LED lamp of claim 14 further comprising a bracket receiving the LED module therein, wherein the bracket defines two engaging holes, and the base has two pivot rods pivotally engaging in the engaging holes of the bracket, respectively.

19. The LED lamp of claim 18 further comprising an electrical connector module attached to the bracket for supplying electric power to the LED module.

20. The LED lamp of claim 19, wherein the electrical connector module comprises two conductive plates electrically connecting with the LED module and a connector having a positive electrode and a negative electrode respectively connecting to the two conductive plates.
